(19) United States
(12) Patent Application Publication
(10) Pub. No.: US 2003/0123972 A1
(43) Pub. Date: Jul. 3, 2003

(54) Method of standardizing compressor design

(76) Inventors: Ralph L. Quetel, North Caldwell, NJ (US); Edward B. Schenone, Scotch Plains, NJ (US)

Correspondence Address: Philip H. Von Neida, The BOC Group, Inc., Intellectual Property Dept., 100 Mountain Ave., Murray Hill, NJ, 07974, US

(21) Appl. No.: 10/254,913

(22) Filed: Sep. 25, 2002

Related U.S. Application Data
(60) Provisional application No. 60/328,189, filed on Oct. 9, 2001.

(51) Int. Cl. F03D 1/00

(52) U.S. Cl. 415/1

(57) ABSTRACT

An integrally geared compressor used in air separation plants may be designed according to specified capacity requirements using standardized components with the disclosed method. The components that are standardized include frames, bull gears, and pinions. First, depending on the specified capacity requirements, a frame is selected from a pre-selected group of frame sizes. Next, depending on the frame selected, a bull gear is selected. Then, depending on the frame selected and the specified capacity requirements, pinions to be driven by the selected bull gears are selected.

This application claims priority from U.S. Provisional Patent Application Serial No. 60/328,189 filed Oct. 9, 2001.

### TECHNICAL FIELD

This invention relates to a method of designing an integrally geared compressor to achieve the specified capacity requirements without the need for substantial customization. More particularly, this invention relates to a method by which an integrally geared compressor for an air separation plant can be designed using a maximum number of standardized components.

### BACKGROUND ART

It is common to use integrally geared compressors in the air separation business. These compressors supply air at a specified output flow rate and output pressure to an air separation plant, and while they function adequately for such purpose, those in the air separation industry recognize that there is a trade-off between absorbed power and mechanical/aerodynamic efficiency when using these compressors.

One of the major concerns of the industry is the cost of power usage. Therefore, integrally geared compressors have historically been designed to maximize mechanical and aerodynamic efficiency in order to minimize plant power costs. However, in addition to the specified requirements of output flow rate and output pressure, the design of each compressor had to account for geographically specific factors such as inlet air temperature, inlet air pressure, and relative atmospheric humidity. Furthermore, in addition to these geographically specific factors, aerodynamic efficiency in particular is dependent on a number of factors including the specified capacity requirements. Therefore, to meet the specified requirements of each air separation plant with the most efficient mechanical and aerodynamic design possible, each compressor was designed differently, that is, customized.

While such custom-designed compressors are able to significantly minimize the level of power absorbed, they are inherently expensive to manufacture. Because each customized compressor must be individually engineered, there are expenses inherent in the time to design and manufacture the customized components that make up the compressor. Furthermore, rather than spreading the costs associated with engineering design and manufacture of the compressor over multiple common standardized compressors, these expenses are consolidated against the cost of a single customized compressor. For example, the components of each customized compressor, including gear housings, bull gears, and pinions, must all be designed and manufactured specifically for each compressor application. Also, each air separation plant is burdened with the expense of maintaining an onsite inventory of spare parts because replacements for these parts would also be customized. As a result, these fixed costs represent a significant amount of capital.

Now, according to those in the industry, such capital could be more advantageously used to operate the air separation plant. As a result, those in the industry are willing to consider the advantages associated with standardized designs while understanding the inherent sacrifice of utilizing a less energy efficient compressor design. Therefore, the need exists for a method of designing an integrally geared compressor using standardized components, without sacrificing the ability to supply air at a specified output pressure and output flow rate.

### DISCLOSURE OF THE INVENTION

It is thus an object of the present invention to provide a method for designing an integrally geared compressor for air separation plants.

It is another object of the present invention to provide a method, as above, where the compressor is designed by selecting from preselected standardized components.

It is a further object of the present invention to provide a method, as above, where the preselected standardized components include bull gears and pinions within a family of machine frame sizes.

It is an additional object of the present invention to provide a method, as above, in which the compressor frame size is selected from a group of pre-determined frame sizes, each corresponding to different ranges primarily dictated by the required output flow rate or more specifically, the volumetric flow rate.

It is yet another object of the present invention to provide a method, as above, in which the bull gears are selected according to the selected frame.

It is still another object of the present invention to provide a method, as above, in which the pinions are selected according to the selected frame and specified requirements of output flow rate and output pressure.

It is still a further object of the present invention to provide a method, as above, wherein the design is optimized by configuring diffusers, impellers, and volutes to refine the output flow rate, output pressure, and performance of the compressor.

These and other objects of the present invention, as well as the advantages thereof over existing prior art forms, which will become apparent from the description to follow, are accomplished by the improvements hereinafter described and claimed.

In general, a method of designing a compressor according to specified requirements in accordance with the present invention includes the steps of selecting a frame from a group of frame sizes that depend on the required output flow rate, then, depending on the frame selected, a bull gear is selected, and, depending on the frame selected and the specified capacity requirements, pinions to be driven by the selected bull gear are selected.

A preferred exemplary method of designing a compressor is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a schematic depiction of an integrally geared compressor including the flow paths for main air service and booster air service.

FIG. 2 is a schematic depiction of an individual compression assembly.

FIG. 3 is a graph of the compressor performance for main air service according to frame size.

FIG. 4 is a graph of the compressor performance based on different pinion selections available for one frame size for booster air service.

### PREFERRED EMBODIMENT FOR CARRYING OUT THE INVENTION

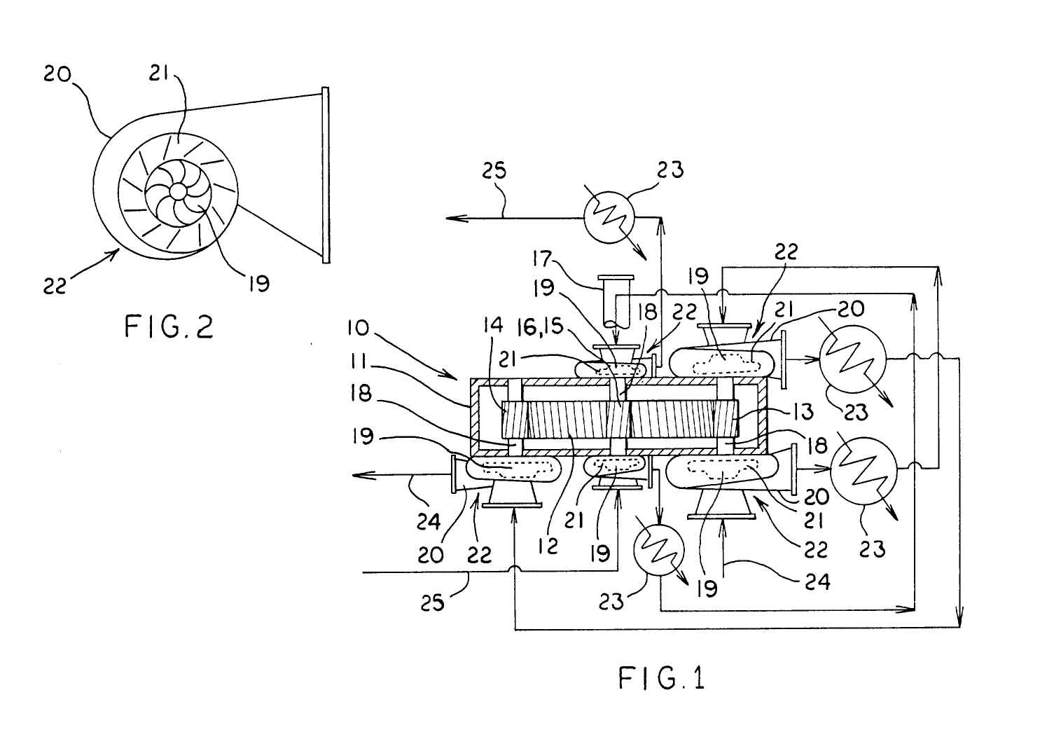

A conventional arrangement for an integrally geared compressor is schematically shown in FIG. 1 and is generally indicated by the numeral 10. Compressor 10 includes a frame 11 which provides support for the components of compressor 10. Frame 11 includes a cavity which acts as a gear casing providing support for a bull gear 12 and pinions 13, 14, 15, and 16. As such, pinion 15 cannot be shown in FIG. 1, but it is indicated as being coupled with pinion 16 because it is located under bull gear 12 opposite pinion 16. Bull gear 12 is positioned generally in the center of the cavity and is driven by a drive shaft 17 normally powered by an electric motor (not shown).

Pinions 13, 14, 15, and 16 are positioned equidistant to each other around the circumference of bull gear 12. Analogizing this arrangement to the face of a clock, pinion 13 is positioned at three o'clock, pinion14 is positioned at nine o'clock, pinion 15 is positioned at six o'clock, and pinion 16 is positioned at twelve o'clock. Pinions 13, 14, 15, and 16 interface with and are driven by bull gear 12 at each of these positions, and are connected to shafts 18 that drive impellers 19.

As seen in FIG. 1 and, more specifically, in FIG. 2, impellers 19, along with volutes 20 and diffusers 21, form the compression assemblies 22. A compression assembly 22 is positioned at each end of the pinions 13, 14, 15, and 16 thereby defining the connection between these pinions and impellers 19 through shafts 18. Each compression assembly 22 constitutes a stage of compression.

The configuration of compressor 10 allows multiple compression assemblies 22 to be attached in series to form paths of compression. As a result, multiple stages of compression can be used to compress the air in each path of compression. The use of multiple stages of compression is advantageous because as the air is compressed, the temperature of the air increases which increases the amount of work required to continue compression. However, when multiple stages of compression are used in conjunction with interstage gas coolers 23, the gas can be cooled between stages which increases the efficiency of compressor 10 thereby decreasing the work of compression.

The air separation plant requires two different supplies, one for main air service and one for booster air service. As a result, there are two paths of compression through compressor 10, one for main air service 24 and another for booster air service 25. Each path of compression uses multiple compression assemblies 22 to compress air over a number of compression stages. The number of compression stages in each path is determined by the specified output pressure requirements and the design of the compressor 10.

Main air service path 24 has three stages of compression and booster air service path 25 has up to a maximum of four stages of compression (as shown in FIG. 1, booster air service path 25 has two stages of compression). However, compressor 10 is first designed to meet the specified requirements of main air service. Therefore, the range of output flow rates and output pressures available for booster air service is constrained by the specified requirements for main air service. However, this situation is remedied by increasing the number of available pinion selections for booster air service.

The configuration of compressor 10 designed in accordance with the present invention and is intended to meet the specified requirements of air separation plant for both main air service and booster air service. The present invention involves the selection of components of compressor 10. The configuration of each component affects the output flow rate and output pressure of compressor 10. Therefore, each progressive selection is directed toward configuring the design of compressor 10 to meet the specified compressor performance requirements of output flow rate and output pressure. In fact, each progressive selection further narrows the output flow rate and output pressure of compressor 10 to a more specific range of output flow rate and output pressure as required by the air separation plant.

First, frame 11 is selected dependent on the specified output flow rate requirements for main air service. Then, bull gear 12 is selected dependent on the frame selected and the available motor input shaft speed (dependent on whether the application is in a 50 or 60 Hertz location). Next, pinions 13 and 14 which are associated with main air service and pinions 15 and 16 which are associated with booster air service are selected dependent on the frame selected and the specified requirements. Finally, impellers 19, volutes 20, diffusers 21, and interstage gas coolers 23 are configured according to the specified output flow rate and output pressure requirements. Each step further narrows the output flow rate and output pressure of compressor 10 to meet the specified requirements.

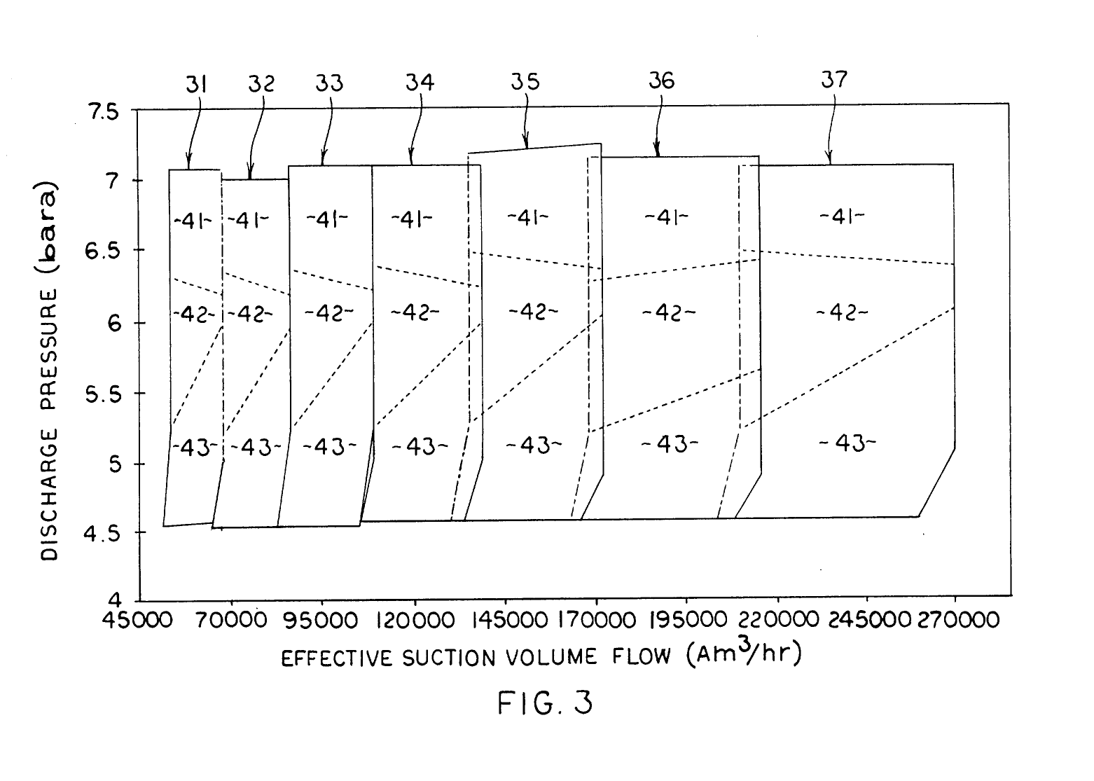

In this standardized process, the manner in which frame 11 is selected can be best described with reference to FIG. 3. FIG. 3, a graph of output pressure versus volumetric flow rate, is divided into seven sections 31-37 corresponding to the output pressure and volumetric flow rate capacities of a possibility of seven different and successively larger standardized frame sizes. Each of the seven standardized frame sizes is physically larger than the next and have the capacity to supply successively higher ranges of volumetric flow rates for the design of compressor 10. These successively higher ranges of volumetric flow rates overlap slightly. Without the overlap, the combined capacities of all the frame sizes could not cover all the possible ranges of specified requirements. For example, the maximum flow capability of the frame size of section 31 would be the same as the minimum flow capability of the frame size of section 32 without the overlap. As a result, the available capacities of neither frame could satisfy a range of specified requirements that included that intersection without interruption. However, the overlap buffers the capacities of each frame to provide a tolerance for avoiding any interruption. Consequently, the combined capacities of all the frame sizes can cover all the possible ranges of specified requirements.

Referring again to FIG. 3, frame 11 is selected by matching specified requirements of air separation plant for main air service to one of the seven frame sizes. For example, if the air separation plant requires a range of output pressure of 5.5 to 6 bara and output flow rate of 120,000 to 121,000 Am³/hr. for main air service, then the frame size of section 34 would be selected. Alternatively, if the air separation plant requires a range output pressure of 6.5 to 7.0 bara and output flow rate of 195,000 to 196,000 Am³/hr. for main air service, then the frame size of section 36 would be selected.

The next component of compressor 10 to be selected is bull gear 12. The selection of bull gear 12 is dependent on the frame selected in the previous step. For each frame size there are fifty and sixty hertz bull gears available to correspond to different electrical system geographies worldwide. Each fifty and sixty hertz bull gear is sized to impart enough power to enable the design of the compressor 10 to supply the maximum output flow rate and output pressure associated with the selected frame size. However, most often the maximum output flow rate and output pressure associated with a frame size is not required. Therefore, the compressor 10 may be designed using components that do not need all the power imparted by the bull gear 12. As a result, the bull gear 12 may be oversized for the specified requirements, but such a design is necessary to permit standardization and accommodate the entire range of output flow rates and output pressures of the compressor 10 designed using that frame size. For example, if the frame is of the size corresponding to section 34 and the speed of the drive shaft 17 is sixty hertz, then the sixty hertz bull gear will be selected. The sixty hertz bull gear is able to provide enough power so as to permit the compressor 10 designed using the frame size of section 34 to achieve the maximum output flow rate and output pressure, if necessary.

Next, pinion 14 that drives a compressor assembly 22 aligned in the main air service path 24 is selected. The selection of pinion 14 further narrows the discharge pressure capability of compressor 10 associated with the selected frame size to a more specific range of discharge pressure for main air service. There are three stages of compression associated with main air service path 24. For each frame size, the first and second stages of compression are associated with pinion 13, and the third stage of compression is associated with pinion 14. In accordance with the present invention, there is a fixed pinion size for pinion 13 for each frame size, and two pinion sizes available for pinion 14. The pinion size selections for pinion 14 correspond to different speeds, fast and slow. The pinions will determine the speed of the impellers and dictate the amount of compression each compression assembly can accomplish. Therefore, the fast pinion selection is associated with a high range of output pressure and the slow pinion selection is associated with a low range of output pressure. There is overlap between the high and low ranges.

In the standardization process, the manner in which pinion 14 is selected can be best described with reference to FIG. 3. The sections 31-37 are each divided into three sections, 41-43. Section 41 corresponds to the fast pinion alternative for pinion 14, section 42 corresponds to the overlap between fast and slow pinion alternatives, and section 43 corresponds to the slow pinion alternative. Pinion 14 is selected by matching the specified requirements for main air service to either the fast or slow pinion alternative. However, as illustrated by the overlap of the capacities of the fast and slow pinon alternatives available for pinion 14 indicated by section 42, the designer must make a decision concerning which pinion alternative is best suited for providing the specified requirements. For example, if the specified requirements for main air service are 120,000 to 121,000 Am³/hr. and 5.5 to 6 bara, then frame size of section 34 would be selected and the slow pinion 43 may be selected for pinion 14. Alternatively, if the specified requirements for main air service are 195,000 to 196,000 Am³/hr. and 6.5 to 7 bara, then frame size of section 36 would be selected and the fast pinion 41 would be selected for pinion 14.

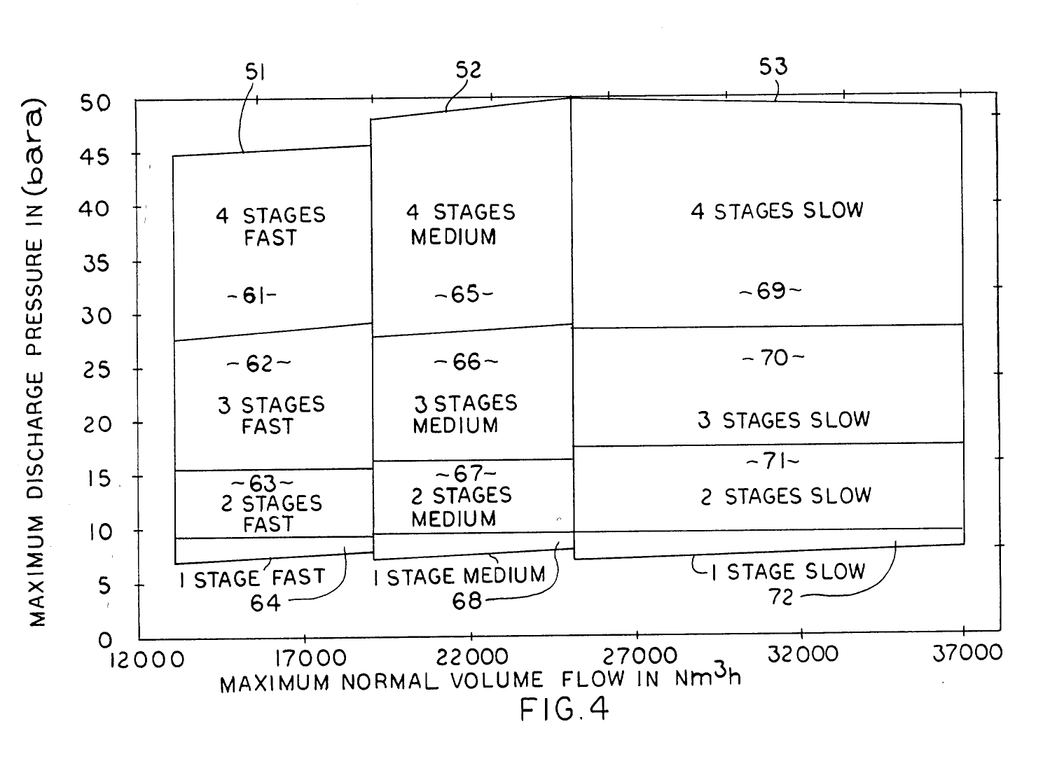

The manner in which pinions 15 and 16 for booster air service path 25 are selected can be seen with reference to FIG. 4. FIG. 4 is a graph of output pressure versus volumetric flow rate and illustrates the output pressure and volumetric flow rate capacities for booster air service for the frame size of section 31. The remaining frame sizes will have similar diagrams with successively larger output capacities. The range of output flow rates and output pressures of the compressor for booster air service path 25 is constrained because the frame was selected to satisfy the specified requirements for main air service. As a result, in order to compensate for such constraints, there are three standardized pinion combinations of pinions 15 and 16 providing for fast, medium, and slow speeds, and there is a possibility of up to 4 stages of compression for each frame size. The pinion combination selected and the number of stages of compression selected will determine the range of output flow rates and output pressures available for booster air service.

To illustrate the selection process, FIG. 4 is divided into three sections 51-53 corresponding to the available pinion combinations. Section 51 defines the range of output flow rate and output pressure capacities for the fast speed pinion combination, section 52 defines the same for the medium speed pinion combination, and section 53 defines the same for the slow speed pinion combination.

Each section 51-53 is then divided into 4 parts corresponding to the number of stages of compression. For example, section 51 corresponding to the fast pinion speed combination has part 61 associated with four stages of compression, part 62 corresponding to three stages of compression, part 63 corresponding to two stages of compression, and part 64 corresponding to one stage of compression. Similarly, section 52 is divided into parts 65-68 and section 53 is divided into parts 69-72 defining the range of capacities for four, three, two, and one stages of compression for the corresponding pinion combinations. Altogether, FIG. 4 is divided into 12 parts 61-72 defining a range of capacities for booster air service. Pinions 15 and 16 are selected by matching the specified requirements of the air separation plant for booster air service to one of these parts 61-72. Therefore, if the specified volumetric flow rate and output pressure requirements for booster air service is in the range of 22,000 to 22,500 Nm³/hr and 20 to 25 bara, then the medium speed pinion combination would be selected for pinions 15 and 16 requiring three stages of compression.

The selection of frame 11, bull gear 12, and pinions 13, 14, 15, and 16 with the specified method allows compressor 10 to be designed to supply a specific range of output flow rates and output pressures. Once the desired frame 11, bull gear 12, and pinions 13, 14, 15, and 16 have been selected, the compression assemblies 22, composed of impellers 19, volutes 20, and diffusers 21 are configured to optimize the design of compressor 10 to supply an even more specific range of output flow rates and output pressures.

The impellers 19, volutes 20, and diffusers 21 are each designed, using computer modeling techniques, to function in conjunction with each other to effect the compressor performance. Specifically, the design of the impellers 19, volutes 20, and diffusers 21 can be modified in the following ways to effect the performance of the compressor. For example, diffusers 21 can be modified by adding or subtracting the number of vanes, altering the curvature of the vanes, or deciding to eliminate the vanes altogether. Furthermore, impellers 19 can be modified by changing diameter of the impeller, the height of the impeller blading (or wheel cuts), and the curvature of the impeller blading. Finally, volutes 20 are designed after the impellers 19 and diffusers 21 have been configured. The design of the volutes 20 is determined by the capacity flow throughput of the compressor, physical dimensions of the diffuser and impeller configuration, and aerodynamic efficiency of the volute itself. The computer modeling techniques are used to reconcile the most efficient configuration of each of these components to produce a design for achieving the specified compressor performance requirements. As described above, the use of computer modeling techniques allows for some customization to refine the results of the present invention.

Once the configuration of the compression assemblies 22 has been finalized, the interstage gas coolers 23 are chosen to correspond to the heat load requirements. The interstage gas coolers 23 are placed after each stage of compression. Cooling the compressed gas after each stage of compressions enhances the efficiency of the compression process, is well known in the art.

In light of the foregoing, it should thus be evident that the method of designing the compressor allows for the use of standardized components while retaining the flexibility to achieve the specific range of output flow rates and output pressures required. It can be seen that the objects of the present invention have been satisfied by the description presented above. While only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A method of designing a compressor according to specified capacity requirements comprising the steps of:
selecting a frame from a preselected group of frame sizes depending on the capacity requirements;
selecting a bull gear depending on the frame selected; and
selecting pinions to be driven by the selected bull gears depending on the frame selected and the capacity requirements.

2. The method according to claim 1, wherein the specified capacity requirements are ranges of output pressures and output flow rates.

3. The method according to claim 2, wherein each frame in the preselected group of frame sizes correspond to a different range of output pressure and output flow rate capacities.

4. The method according to claim 3, wherein the ranges of output flow rates of the different frames increase with each subsequently larger frame size.

5. The method according to claim 4, wherein the ranges of output pressures and output flow rates of each subsequently larger frame size overlap.

6. The method according to claim 1, wherein within each frame size there are two alternatives of bull gears.

7. The method according to claim 6, wherein each of the two alternatives are 50 hertz and 60 hertz bull gears.

8. The method according to claim 7, wherein each of the alternatives of bull gears is rated at the maximum power capability of the corresponding frame size.

9. The method according to claim 8, wherein the maximum output pressure and output flow rate capacities of a frame size are able to be achieved using the maximum power capability associated with that frame size.

10. The method according to claim 1, wherein the step of selecting pinions depends on the specified capacity requirements for main air service and booster air service.

11. The method according to claim 10, wherein the step of selecting pinions depends on the number of stages of compression necessary to satisfy the specified output pressure requirements for main air service and booster air service.

12. The method according to claim 11, wherein the step of selecting pinions depends on having at least one stage of compression associated with each pinion.

13. The method according to claim 12, wherein booster air service and main air service each have two pinions associated with them.

14. The method according to claim 13, wherein the step of selecting pinions to satisfy the service requirements of the main air service depends on three stages of compression, with the one pinion driving the first and second stages and the other pinion driving the third stage.

15. The method according to claim 14, wherein the step of selecting pinions to satisfy the service requirements for main air service involves having one pinion selection for the pinion driving the first and second stages and having two selections for the pinion driving the third stage.

16. The method according to claim 13, wherein the step of selecting pinions to satisfy the service requirements of booster air service depends on a possibility of four stages of compression, with the one pinion driving the first and second stages and the another driving the third and fourth stages.

17. The method according to claim 16, wherein the step of selecting pinions to satisfy the service requirements for booster air service involves having three combinations of pinion selections.

18. The method according to claim 1, further comprising the step of designing diffusers, impellers, and volutes to optimize the performance of the compressor.

19. The method according to claim 18, wherein the step of designing diffusers, impellers, and volutes depends on optimizing the range of possible output pressures and output flow rates to correspond to the specified capacity requirements.

20. The method according to claim 19, wherein the step designing diffusers, impellers, and volutes depends on assuring the minimum specified capacity requirements can be supplied.

21. The method according to claim 1, further comprising the step of selecting interstage gas coolers.

22. The method according to claim 21, wherein the step of selecting interstage gas coolers depends on the heat load between the stage of compression.
